(19) United States
(12) Patent Application Publication
(10) Pub. No.: US 2026/0346921 A1
(43) Pub. Date: Nov. 5, 2026

(54) ROOF ASSEMBLY COMPRISING PANORAMIC GLASS ELEMENT

(71) Applicant: AUDI AG, Ingolstadt (DE)

(72) Inventor: Patrick REDS, Ingolstadt (DE)

(73) Assignee: AUDI AG, Ingolstadt (DE)

(21) Appl. No.: 19/102,875

(22) PCT Filed: Aug. 11, 2023
(86) PCT No.: PCT/EP2023/072296

§ 371 Date: Feb. 11, 2025

(30) Foreign Application Priority Data
Sep. 21, 2022 (DE) 102022124157.2

(51) Int. Cl. B62D 25/06; B60R 13/02; H01Q 1/32

(52) U.S. Cl. CPC B62D 25/06; B60R 13/0231; H01Q 1/3275

(57) ABSTRACT

A roof arrangement for a motor vehicle with at least one panoramic glass element; at least one roof liner element which is arranged along an edge region of the panoramic glass element and which has a cutout in the region of its rear edge; and with at least one sheet metal element which is arranged in the cutout and which is designed to be connected at least indirectly to a roof antenna. At least one clamp-like coupling element is arranged on the sheet metal element, and at least one locking element is arranged on the roof liner element in the region of the cutout of the panoramic glass element, which locking element is designed to correspond to the coupling element, such that the roof liner element can be connected or is connected to the sheet metal element in the region of the cutout.

### FIELD

The invention relates to a roof arrangement for a motor vehicle with at least one panoramic glass element, at least one roof liner element which is arranged along an edge region of the panoramic glass element and which has a cutout in the region of its rear edge; and with at least one sheet metal element which is arranged in the cutout and which is designed to be connected to a roof antenna.

### BACKGROUND

The use of so-called panoramic glass roofs, which can be made from one piece or from several glass parts that can optionally be moved relative to one another, has proven to be an effective means of influencing the vehicle height, especially in electrically powered vehicles with a high-voltage battery arranged in the underbody region. Such panoramic glass elements should be as long as possible in relation to the longitudinal direction of the vehicle so that people in a rear row of seats can also sit under glass if possible. Particularly in the case of body shapes with a rear roof frame element located close to the vehicle occupant, such as hatchbacks, sedans, coupes, problems can arise in the arrangement of roof antennas, wherein a conventional roof antenna is a cost-effective solution for connecting the vehicle to the environment in terms of data technology. It is known that the roof antenna must be connected to a sheet metal part in order to be able to receive all signals; in particular, a sheet metal part connected to the antenna can be used as an antenna for a NAR satellite radio. The use of panoramic glass elements and roof antennas therefore results in structural as well as signaling problems.

With regard to roof arrangements with panoramic glass roof and roof liner for motor vehicles, reference is made to the following documents: DE 10 2020 209 264 A1, EP 3 964 400 A1 and DE 10 2017 220 732 A1.

### SUMMARY

The object of the invention is to provide a roof arrangement with panoramic glass element in which the above disadvantages can be reduced or avoided.

The invention thus proposes a roof arrangement for a motor vehicle with at least one panoramic glass element, at least one roof liner element which is arranged along an edge region of the panoramic glass element and which has a cutout in the region of its rear edge; and with at least one sheet metal element which is arranged in the cutout and which is designed to be connected to a roof antenna at least indirectly. It is provided that at least one clamp-like coupling element is arranged on the sheet metal element, and that at least one locking element is arranged on the roof liner element in the region of the cutout of the panoramic glass element, which locking element is designed to correspond to the coupling element, such that the roof liner element can be connected or is connected to the sheet metal element in the region of the cutout.

By means of such a configuration, the sheet metal element with the at least one clamp-like coupling element is used as a holder for the roof liner element, so that the roof liner element can also be fastened in the region of the cutout in the panoramic glass element.

In the roof arrangement, the sheet metal element can be materially connected to the panoramic glass element in the region of the cutout. In particular, the sheet metal element can be glued to the panoramic glass element. This enables an exact and secure connection between the sheet metal element and the panoramic glass element.

In the roof arrangement, the sheet metal element can have a groove portion into which the coupling element can be or is inserted before establishing a connection with the locking element. In particular, the groove portion can serve to insert or hook the coupling element into this groove section so that it protrudes downwards from the sheet metal element, in particular towards the vehicle interior.

In the roof arrangement, the coupling element can have two clamping portions between which the locking element can be received or is received.

The coupling element can in particular be designed as a sheet metal part or sheet metal clamp.

In the roof arrangement, the locking element can have a locking portion so that it can be or is at least partially connected in a form-fitting manner to the clamping portions.

The locking element can in particular be made of a plastic.

Thus, the roof liner element can be attached to or connected to the sheet metal element by snapping the locking element or locking portion in the clamp-like coupling element. This connection can be made in particular after inserting the panoramic glass element with the attached sheet metal part into the vehicle frame, when the roof liner element is moved upwards from below against the sheet metal element in order to be able to establish the locking connection.

The roof arrangement can have a cover element which is arranged in the region of the cutout above the sheet metal element and is connected to the panoramic glass element. Such a cover element can be designed to be essentially flush with the outer side of the panoramic glass element. Furthermore, the cover element can have a substantially central or middle opening through which a roof antenna passes and projects outwards (upwards).

In the roof arrangement, the cutout in the panoramic glass element can be arched or U-shaped and two coupling elements can be arranged on the sheet metal element along an imaginary chord of the cutout. This means that the roof liner element can be reliably fastened and held in place in the cutout region.

In the roof arrangement, a roof antenna can be attached or be attached to the sheet metal element by means of the above-mentioned optional cover element for the cutout.

In the roof arrangement, the roof liner element can have a reinforcing element in the region of the cutout, on which the at least one locking element is formed, wherein in particular the at least one locking element and the reinforcing element are formed integrally with one another. In particular, the reinforcing element and the at least one locking element can be made of a plastic, preferably also formed in one piece.

A motor vehicle with a roof arrangement as described above and equipped with a roof antenna which protrudes outwards over the panoramic glass element in the region of the cutout.

Please note that the panoramic glass element can be a single, continuous panoramic glass roof. However, it is also conceivable that the vehicle roof is formed by two panoramic glass elements, with a front panoramic glass element being movable and a rear panoramic glass element being fixed (panoramic glass sliding roof). In this case, the cutout and the sheet metal element accommodated therein are provided in the rear panoramic glass element.

### BRIEF DESCRIPTION OF THE FIGURES

Further advantages and details of the invention result from the following description of embodiments with reference to the figures. In particular:

FIG. 1 shows a simplified and schematic sectional view of a roof arrangement;

FIG. 2 shows a simplified and schematic plan view of a roof arrangement;

FIG. 3 shows an enlarged, simplified and schematic sectional view of a left part of the roof arrangement of FIG. 1.

### DETAILED DESCRIPTION

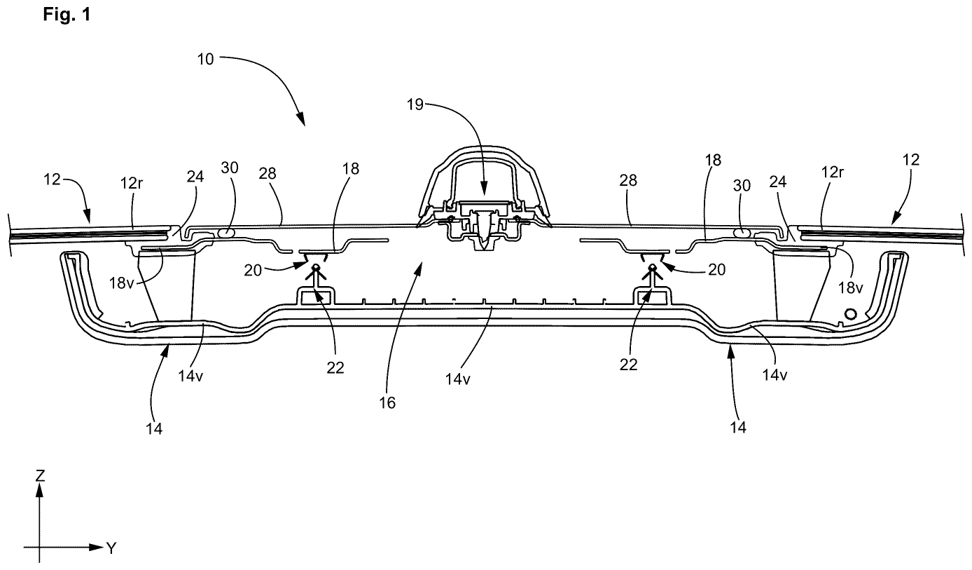

FIG. 1 shows a roof arrangement 10 for a motor vehicle in a simplified and schematic sectional view. The roof arrangement 10 includes a panoramic glass element 12 and a roof liner element 14 arranged along an edge region 12r of the panoramic glass element 12.

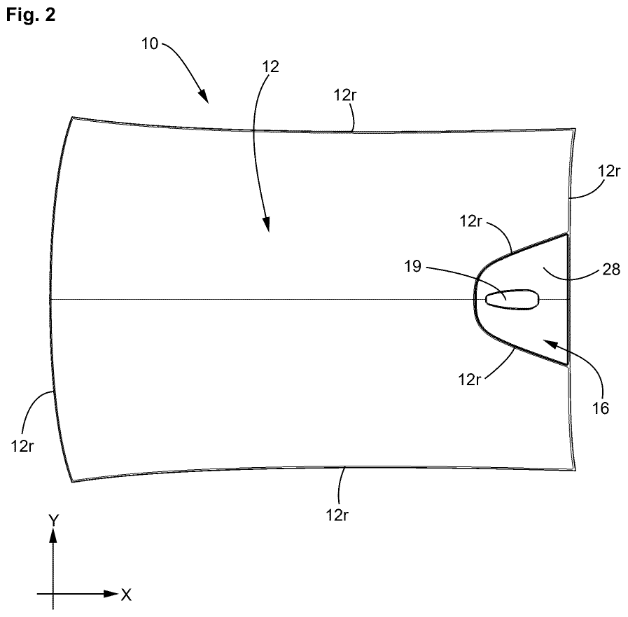

From the simplified plan view of the panoramic glass element 12 shown in FIG. 2, it can be seen that it has a cutout 16 in the region of its rear edge.

Referring again to FIG. 1, it can be seen that a sheet metal element 18 is arranged in the cutout 16. The sheet metal element 18 is designed to be connected at least indirectly to a roof antenna 19. At least one clamp-like coupling element 20 is arranged on the sheet metal element 18. In the example shown, two coupling elements 20 are provided on the sheet metal element 18 in a vehicle width direction Y. Furthermore, it should be noted that in FIGS. 1 to 3, depending on the view, the vehicle longitudinal direction X and the vehicle height direction Z are also indicated.

At least one locking element 22 is arranged on the roof liner element 14 in the region of the cutout 16 of the panoramic glass element 12, which locking element is designed to correspond to the coupling element 20. In the example shown, two locking elements 22 are provided in a vehicle width direction Y. Thus, the roof liner element 14 can be or is connected to the sheet metal element 18 in the region of the cutout 16.

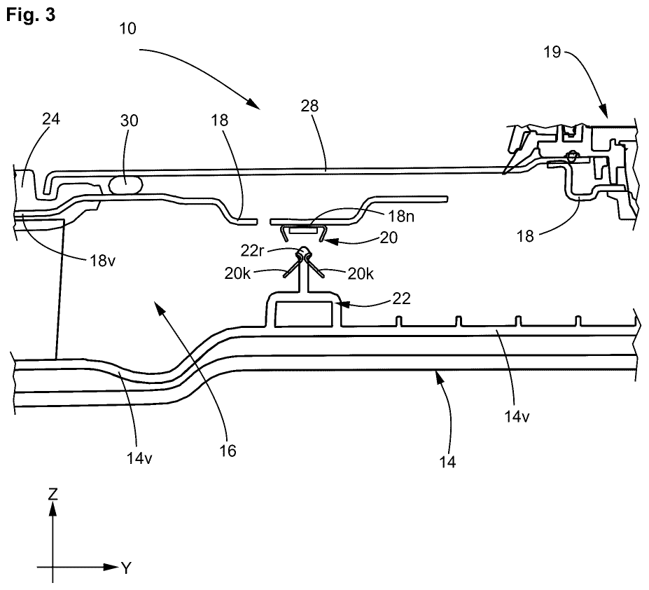

For the following description, reference is also made to the sectional view of FIG. 3, which is an enlargement of the left region of FIG. 1. What has been said above with reference to FIGS. 1 and 2 can also be read as referring to FIG. 3.

From FIGS. 2 and 3 it can be seen that the sheet metal element 18 is materially connected to the panoramic glass element 12 in the region of the cutout 16. For this purpose, the sheet metal element 18 can be formed, for example, with connecting portions 18v which are received in a potting compound 24, wherein the potting compound 24 is provided along the edge region 12r, in particular within the cutout 16.

From FIG. 3 it is shown in a simplified and schematic manner that the sheet metal element 18 has a groove portion 18n into which the coupling element 20 can be or is inserted before establishing a connection with the locking element 22.

The coupling element 20 has two clamping portions 20k, between which the locking element 22 can be received or is received. The locking element 22 has a locking portion 22r, so that a form-fitting connection can be or is established at least partially with the clamping portions 20k.

The coupling element 20 can, for example, be designed as a type of sheet metal clamp. The locking element 22 is preferably pin-shaped and can be made of a plastic.

From FIGS. 1 to 3 it is also apparent that the roof arrangement 10 has a cover element 28 which is arranged in the region of the cutout 16 above the sheet metal element 18 and is at least indirectly connected to the panoramic glass element 12. The cover element 28 can be connected, for example, by means of an adhesive point 30 to the sheet metal element 18, which itself is materially connected to the panoramic glass element 12.

The roof antenna 19 is connected to the cover element 28. The sheet metal element 18 is foamed into the panoramic glass element 12 at 24, which does not yet allow for an outer skin quality for the finished roof arrangement. Therefore, the cover element 28 is glued above the sheet metal element 18. The sheet metal element 18 thus connects the panoramic glass element 12 with the cover element or outer sheet metal 28 and the roof liner element 14.

From FIG. 2 it can be seen that the cutout 16 is curved or U-shaped and that two coupling elements 20 are arranged on the sheet metal element 18 along an imaginary chord, which essentially corresponds to the sectional plane of FIGS. 1 and 3, of cutout 16 (FIG. 1).

From FIGS. 1 and 3 it is further apparent that the roof liner element 14 has a reinforcing element 14v in the region of the cutout 16, on which the at least one locking element 22 is formed. In the example shown, the two locking elements 22 and the reinforcing element 14v are formed integrally with one another, in particular they are made of the same plastic material.

A motor vehicle not shown in detail can be equipped with the roof arrangement 10 as described above with reference to FIGS. 1 to 3 and can be provided with a roof antenna 19 which projects outwards beyond the panoramic glass element 12 in the region of the cutout 16.

### DESCRIPTION

The invention relates to a roof arrangement for a motor vehicle with at least one panoramic glass element, at least one roof liner element which is arranged along an edge region of the panoramic glass element and which has a cutout in the region of its rear edge; and with at least one sheet metal element which is arranged in the cutout and which is designed to be connected to a roof antenna.

The use of so-called panoramic glass roofs, which can be made from one piece or from several glass parts that can optionally be moved relative to one another, has proven to be an effective means of influencing the vehicle height, especially in electrically powered vehicles with a high-voltage battery arranged in the underbody region. Such panoramic glass elements should be as long as possible in relation to the longitudinal direction of the vehicle so that people in a rear row of seats can also sit under glass if possible. Particularly in the case of body shapes with a rear roof frame element located close to the vehicle occupant, such as hatchbacks, sedans, coupes, problems can arise in the arrangement of roof antennas, wherein a conventional roof antenna is a cost-effective solution for connecting the vehicle to the environment in terms of data technology. It is known that the roof antenna must be connected to a sheet metal part in order to be able to receive all signals; in particular, a sheet metal part connected to the antenna can be used as an antenna for a NAR satellite radio. The use of panoramic glass elements and roof antennas therefore results in structural as well as signaling problems.

With regard to roof arrangements with panoramic glass roof and roof liner for motor vehicles, reference is made to the following documents: DE 10 2020 209 264 A1, EP 3 964 400 A1 and DE 10 2017 220 732 A1.

The object of the invention is to provide a roof arrangement with panoramic glass element in which the above disadvantages can be reduced or avoided.

This object is achieved by a roof arrangement and a motor vehicle having the features according to the respective independent claims. Advantageous embodiments with expedient developments are specified in the dependent claims.

The invention thus proposes a roof arrangement for a motor vehicle with at least one panoramic glass element, at least one roof liner element which is arranged along an edge region of the panoramic glass element and which has a cutout in the region of its rear edge; and with at least one sheet metal element which is arranged in the cutout and which is designed to be connected to a roof antenna at least indirectly. It is provided that at least one clamp-like coupling element is arranged on the sheet metal element, and that at least one locking element is arranged on the roof liner element in the region of the cutout of the panoramic glass element, which locking element is designed to correspond to the coupling element, such that the roof liner element can be connected or is connected to the sheet metal element in the region of the cutout.

By means of such a configuration, the sheet metal element with the at least one clamp-like coupling element is used as a holder for the roof liner element, so that the roof liner element can also be fastened in the region of the cutout in the panoramic glass element.

In the roof arrangement, the sheet metal element can be materially connected to the panoramic glass element in the region of the cutout. In particular, the sheet metal element can be glued to the panoramic glass element. This enables an exact and secure connection between the sheet metal element and the panoramic glass element.

In the roof arrangement, the sheet metal element can have a groove portion into which the coupling element can be or is inserted before establishing a connection with the locking element. In particular, the groove portion can serve to insert or hook the coupling element into this groove section so that it protrudes downwards from the sheet metal element, in particular towards the vehicle interior.

In the roof arrangement, the coupling element can have two clamping portions between which the locking element can be received or is received.

The coupling element can in particular be designed as a sheet metal part or sheet metal clamp.

In the roof arrangement, the locking element can have a locking portion so that it can be or is at least partially connected in a form-fitting manner to the clamping portions.

The locking element can in particular be made of a plastic.

Thus, the roof liner element can be attached to or connected to the sheet metal element by snapping the locking element or locking portion in the clamp-like coupling element. This connection can be made in particular after inserting the panoramic glass element with the attached sheet metal part into the vehicle frame, when the roof liner element is moved upwards from below against the sheet metal element in order to be able to establish the locking connection.

The roof arrangement can have a cover element which is arranged in the region of the cutout above the sheet metal element and is connected to the panoramic glass element. Such a cover element can be designed to be essentially flush with the outer side of the panoramic glass element. Furthermore, the cover element can have a substantially central or middle opening through which a roof antenna passes and projects outwards (upwards).

In the roof arrangement, the cutout in the panoramic glass element can be arched or U-shaped and two coupling elements can be arranged on the sheet metal element along an imaginary chord of the cutout. This means that the roof liner element can be reliably fastened and held in place in the cutout region.

In the roof arrangement, a roof antenna can be attached or be attached to the sheet metal element by means of the above-mentioned optional cover element for the cutout.

In the roof arrangement, the roof liner element can have a reinforcing element in the region of the cutout, on which the at least one locking element is formed, wherein in particular the at least one locking element and the reinforcing element are formed integrally with one another. In particular, the reinforcing element and the at least one locking element can be made of a plastic, preferably also formed in one piece.

A motor vehicle with a roof arrangement as described above and equipped with a roof antenna which protrudes outwards over the panoramic glass element in the region of the cutout. Please note that the panoramic glass element can be a single, continuous panoramic glass roof. However, it is also conceivable that the vehicle roof is formed by two panoramic glass elements, with a front panoramic glass element being movable and a rear panoramic glass element being fixed (panoramic glass sliding roof). In this case, the cutout and the sheet metal element accommodated therein are provided in the rear panoramic glass element.

Further advantages and details of the invention result from the following description of embodiments with reference to the figures. In particular:

FIG. 1 shows a simplified and schematic sectional view of a roof arrangement;

FIG. 2 shows a simplified and schematic plan view of a roof arrangement;

FIG. 3 shows an enlarged, simplified and schematic sectional view of a left part of the roof arrangement of FIG. 1.

FIG. 1 shows a roof arrangement 10 for a motor vehicle in a simplified and schematic sectional view. The roof arrangement 10 includes a panoramic glass element 12 and a roof liner element 14 arranged along an edge region 12r of the panoramic glass element 12.

From the simplified plan view of the panoramic glass element 12 shown in FIG. 2, it can be seen that it has a cutout 16 in the region of its rear edge.

Referring again to FIG. 1, it can be seen that a sheet metal element 18 is arranged in the cutout 16. The sheet metal element 18 is designed to be connected at least indirectly to a roof antenna 19. At least one clamp-like coupling element 20 is arranged on the sheet metal element 18. In the example shown, two coupling elements 20 are provided on the sheet metal element 18 in a vehicle width direction Y. Furthermore, it should be noted that in FIGS. 1 to 3, depending on the view, the vehicle longitudinal direction X and the vehicle height direction Z are also indicated.

At least one locking element 22 is arranged on the roof liner element 14 in the region of the cutout 16 of the panoramic glass element 12, which locking element is designed to correspond to the coupling element 20. In the example shown, two locking elements 22 are provided in a vehicle width direction Y. Thus, the roof liner element 14 can be or is connected to the sheet metal element 18 in the region of the cutout 16.

For the following description, reference is also made to the sectional view of FIG. 3, which is an enlargement of the left region of FIG. 1. What has been said above with reference to FIGS. 1 and 2 can also be read as referring to FIG. 3.

From FIGS. 2 and 3 it can be seen that the sheet metal element 18 is materially connected to the panoramic glass element 12 in the region of the cutout 16. For this purpose, the sheet metal element 18 can be formed, for example, with connecting portions 18v which are received in a potting compound 24, wherein the potting compound 24 is provided along the edge region 12r, in particular within the cutout 16.

From FIG. 3 it is shown in a simplified and schematic manner that the sheet metal element 18 has a groove portion 18n into which the coupling element 20 can be or is inserted before establishing a connection with the locking element 22.

The coupling element 20 has two clamping portions 20k, between which the locking element 22 can be received or is received. The locking element 22 has a locking portion 22r, so that a form-fitting connection can be or is established at least partially with the clamping portions 20k.

The coupling element 20 can, for example, be designed as a type of sheet metal clamp. The locking element 22 is preferably pin-shaped and can be made of a plastic.

From FIGS. 1 to 3 it is also apparent that the roof arrangement 10 has a cover element 28 which is arranged in the region of the cutout 16 above the sheet metal element 18 and is at least indirectly connected to the panoramic glass element 12. The cover element 28 can be connected, for example, by means of an adhesive point 30 to the sheet metal element 18, which itself is materially connected to the panoramic glass element 12.

The roof antenna 19 is connected to the cover element 28. The sheet metal element 18 is foamed into the panoramic glass element 12 at 24, which does not yet allow for an outer skin quality for the finished roof arrangement. Therefore, the cover element 28 is glued above the sheet metal element 18. The sheet metal element 18 thus connects the panoramic glass element 12 with the cover element or outer sheet metal 28 and the roof liner element 14.

From FIG. 2 it can be seen that the cutout 16 is curved or U-shaped and that two coupling elements 20 are arranged on the sheet metal element 18 along an imaginary chord, which essentially corresponds to the sectional plane of FIGS. 1 and 3, of cutout 16 (FIG. 1).

From FIGS. 1 and 3 it is further apparent that the roof liner element 14 has a reinforcing element 14v in the region of the cutout 16, on which the at least one locking element 22 is formed. In the example shown, the two locking elements 22 and the reinforcing element 14v are formed integrally with one another, in particular they are made of the same plastic material. A motor vehicle not shown in detail can be equipped with the roof arrangement 10 as described above with reference to FIGS. 1 to 3 and can be provided with a roof antenna 19 which projects outwards beyond the panoramic glass element 12 in the region of the cutout 16.

1-10. (canceled)

11. A roof arrangement for a motor vehicle, comprising:
at least one panoramic glass element;
at least one roof liner element which is arranged along an edge region of the panoramic glass element and which has a cutout in the region of its rear edge;
at least one sheet metal element which is arranged in the cutout and which is designed to be connected at least indirectly to a roof antenna,
at least one clamp-like coupling element is arranged on the sheet metal element, and
at least one locking element is arranged on the roof liner element in the region of the cutout of the panoramic glass element, which locking element is designed to correspond to the coupling element, such that the roof liner element can be or is connected to the sheet metal element in the region of the cutout.

12. The roof arrangement according to claim 11, wherein the sheet metal element is materially connected to the panoramic glass element in the region of the cutout.

13. The roof arrangement according to claim 11, wherein the sheet metal element has a groove portion into which the coupling element can be or is inserted before establishing a connection with the locking element.

14. The roof arrangement according to claim 11, wherein the coupling element has two clamping portions, between which the locking element can be received or is received.

15. The roof arrangement according to claim 14, wherein the locking element has a locking portion so that it can be or is connected in a form-fitting manner at least partially to the clamping portions.

16. The roof arrangement according to claim 11, further comprising: a cover element which is arranged in the region of the cutout above the sheet metal element and is connected to the panoramic glass element.

17. The roof arrangement according to claim 11, wherein the cutout is curved or U-shaped and that two coupling elements are arranged on the sheet metal element along an imaginary chord of the cutout.

18. The roof arrangement according to claim 16, wherein a roof antenna can be or is fastened to the sheet metal element by the cover element for the cutout.

19. The roof arrangement according to claim 11, characterized in that the roof liner element has a reinforcing element in the region of the cutout, on which the at least one locking element is formed, wherein in particular the at least one locking element and the reinforcing element are formed integrally with one another.

20. A motor vehicle with a roof arrangement according to claim 11 and with a roof antenna which projects outwards beyond the panoramic glass element in the region of the cutout.

21. The roof arrangement according to claim 12, wherein the sheet metal element has a groove portion into which the coupling element can be or is inserted before establishing a connection with the locking element.

22. The roof arrangement according to claim 12, wherein the coupling element has two clamping portions, between which the locking element can be received or is received.

23. The roof arrangement according to claim 13, wherein the coupling element has two clamping portions, between which the locking element can be received or is received.

24. The roof arrangement according to claim 12, further comprising: a cover element which is arranged in the region of the cutout above the sheet metal element and is connected to the panoramic glass element.

25. The roof arrangement according to claim 13, further comprising: a cover element which is arranged in the region of the cutout above the sheet metal element and is connected to the panoramic glass element.

26. The roof arrangement according to claim 14, further comprising: a cover element which is arranged in the region of the cutout above the sheet metal element and is connected to the panoramic glass element.

27. The roof arrangement according to claim 15, further comprising: a cover element which is arranged in the region of the cutout above the sheet metal element and is connected to the panoramic glass element.

28. The roof arrangement according to claim 12, wherein the cutout is curved or U-shaped and that two coupling elements are arranged on the sheet metal element along an imaginary chord of the cutout.

29. The roof arrangement according to claim 13, wherein the cutout is curved or U-shaped and that two coupling elements are arranged on the sheet metal element along an imaginary chord of the cutout.

30. The roof arrangement according to claim 14, wherein the cutout is curved or U-shaped and that two coupling elements are arranged on the sheet metal element along an imaginary chord of the cutout.
